(19) United States
(12) Patent Application Publication
(10) Pub. No.: US 2026/0220482 A1
(43) Pub. Date: Jul. 30, 2026

(54) PRETTY SIMPLE COMPRESSION (PISCO) FOR RETRIEVAL AI-AUGMENTED GENERATION (RAG)

(71) Applicant: Naver Corporation, Gyeonggi-do (KR)

(72) Inventors: Maxime Louis, Grenoble (FR); Hervé Déjean, Grenoble (FR); Stéphane Clinchant, Meylan (FR); Thibault Formal, Saint-Ouen-sur-Seine (FR)

(73) Assignee: Naver Corporation, Gyeonggi-do (KR)

(21) Appl. No.: 19/415,543

(22) Filed: Dec. 10, 2025

Related U.S. Application Data
(60) Provisional application No. 63/749,881, filed on Jan. 27, 2025.

(51) Int. Cl. G06N 3/096

(52) U.S. Cl. CPC G06N 3/096

(57) ABSTRACT

The present disclosure relates to techniques for enhancing retrieval-augmented generation (RAG) pipelines by efficiently reducing a length of retrieved context into compressed representations. The length of the compressed representations may be orders of magnitude smaller than the length of the retrieved context and thus achieve a substantial speed-up in response generation by a RAG, while maintaining similar accuracy as compared to traditional RAG. In some aspects, pretty simple compression (PISCO) techniques are disclosed for training and deploying generative artificial intelligence (AI) models within a RAG pipeline. Accordingly, the PISCO techniques may employ two generative AI models: a compressor model producing the compressed representations and a generator model generating a response based on a received user query and the compressed representations of the retrieved passages. Both the models may correspond to fine-tuned modifications of the same (or different) base models, potentially be trained based on unlabeled data via sequence-level knowledge distillation.

### CROSS-REFERENCE TO RELATED APPLICATIONS

This application claims the priority to and the benefit of U.S. Provisional Application No. 63/749,881, filed on Jan. 27, 2025, which is hereby incorporated by reference in its entirety for all purposes.

### BACKGROUND

Large language models (LLMs) are artificial intelligence (AI) models trained on vast amounts of textual data to understand and generate human-like language. LLMs may be used for tasks such as text generation, summarization, translation, coding, question answering, and conversational AI across various domains such as healthcare, education, customer service, and the like. An LLM may process the text inputs by splitting into tokens using a tokenizer, where the tokens may be words, sub-words, or characters of the raw text. Moreover, embeddings may refer to vector representations of tokens that encode the meaning and relationships in a format which the model may process. An embedding is a dense numerical representation (a vector of floating-point values) of a token or some concept. The embedding is a vector in a continuous vector space, typically of fixed size (e.g., 512 or 1024 dimensions). Given a large training time and computing resource utilization, a frequent re-training of LLM is usually not possible. Thus, the LLMs may frequently generate outdated responses, poor responses on a particular domain, or may include hallucinated information (e.g., output containing inaccuracies or nonsensical text).

Retrieval-augmented generation (RAG) pipelines may provide accurate answers by incorporating up-to-date, context-specific knowledge from external sources. By incorporating documents retrieved from a selected collection, RAG enhances LLMs to generate more accurate, current, and domain-specific responses. However, a primary drawback may be the increased inference cost, which scales quadratically with the number of tokens and, consequently, with the number of retrieved documents when using transformer-based architectures. In addition to inference costs, the limitations on LLM context size restrict the number of documents and thus the amount of information that may be utilized. These constraints limit the potential scaling of inference using RAG.

Therefore, it is important to develop faster and accurate RAG pipelines to address scalability issues. Providing solutions to these challenges will improve the efficiency, throughput, accuracy, and deployment of RAG pipelines for various applications.

### SUMMARY

Certain aspects and features of the present disclosure relate to techniques for enhancing retrieval-augmented generation (RAG) pipelines with improved latency and throughput by efficiently reducing a length of retrieved contexts into compressed representations. More specifically, techniques are provided for training and deploying generative artificial intelligence (AI) models to improve a RAG pipeline. This may be achieved by applying a simple compression (PISCO) framework to generate the compressed representations (or embeddings) for the retrieved contexts associated with a user query. In some aspects, for training a RAG, a set of training queries associated with a given modality may be accessed. For example, a training query may be textual, image-based, audio-based, or a multimodal such as image along with text. For each training query, a corresponding set of training data items may be retrieved from a training data collection. Examples of the set of training data items may include documents, reference images, videos, or multimodal data depending on an application domain of the RAG.

The set of training queries and the retrieved set of training data items (context) may then be processed by a teacher generative model to produce a teacher output (e.g., a textual answer, generated image, caption, or sequence continuation). For each retrieved training data item, a compressed representation may be generated by leveraging a compressor model that is configured to reduce the length of a retrieved training data item while retaining query-relevant information. Subsequently, the retrieved training query along with compressed representations of the corresponding training data items may be processed by a generator model that, based on the provided input, is configured to generate a predicted output corresponding to the training query. Both the generator model and the compressor model may be trained by determining a loss function based on a difference between the teacher output and the predicted output generated by the generator model. The training may involve updating (parameters of) these models through a backpropagation technique that is guided by sequence-level knowledge distillation in which the loss function is determined over the entire output sequence rather than on a token-by-token basis.

Once the training is completed, a trained compressor model and a trained generator model are obtained that were jointly trained such that the trained generator model is capable of reconstructing teacher-quality outputs from compressed, query-specific representations generated by the trained compressor model for the corresponding retrieved set of training data items.

Examples of the generative AI models that may be used in retrieval-augmented generation (RAG) pipelines may include, but are not limited to, large language models (LLMs) for text generation (e.g., GPT-4, Claude, LLAMA, Mistral, Gemini), diffusion-based models for image, video, or audio synthesis (e.g., Stable Diffusion, Imagen, DALL E, AudioLDM), autoregressive or transformer-based multimodal models that jointly process and generate across text, image, and audio domains (e.g., GPT-4V, Flamingo, BLIP-2, Kosmos-2), as well as generative adversarial networks (GANs) or variational autoencoders (VAEs) for domain-specific synthesis and reconstruction tasks.

In certain examples, the generation of the compressed representations further includes encoding each training data item at a given compression rate by appending a set of learnable memory tokens to each training data item. Each training data item may thereby be encoded into multiple compressed representations, where the number or dimensionality of the resulting representations are determined by the number of appended memory tokens, which is less than the initial or original length (or size) of the training data item. In some instances, the given compression rate may vary across different retrieved training data items corresponding to the training query. Similarly, in some instances, the compression rate may vary in accordance with the size of the retrieved training data item.

Through sequence-level knowledge distillation (SKD), a teacher model may generate teacher responses that serve as supervisory signals to jointly fine-tune the compressor model and the generator model. The fine-tuning may involve updating a compressor adapter and a generator adapter, such as low-rank adaptation (LoRA) modules or other similar lightweight, learnable components. In some examples, the compressor model and the generator model may each include a separate set of learnable adapters, enabling task-specific fine-tuning of the respective compressor and generator models while maintaining a shared or distinct base model. In some instances, the teacher, generator and the compressor models may be modifications of a same base generative AI model (e.g., a backbone LLM such as Solar, or Mistral-7B for textual data). In some other instances, the teacher, generator and compressor models may correspond to a different base generative AI model.

In some aspects, the disclosed PISCO techniques may not rely on any pre-training of the compressor and the generator models, rather, may potentially be trained using unlabeled data via sequence-level knowledge distillation (where ground truth labels correspond to the teacher outputs that are generated by the teacher model during training). During the training process, the learnable adapters in the compressor model and the generator model are updated (or trained) to minimize the loss function. For example, a cross-entropy loss may be computed between the teacher outputs generated by the teacher model and predicted outputs generated based on a combination of the compressed representations associated with the retrieved training data items and the received query.

Based on the training query, a score may be generated for each training data item that is retrieved corresponding to the training query. The score may reflect a degree of (contextual) relevancy between the retrieved training data item and the training query, thereby enabling selection or re-ranking of the most relevant training data items. Subsequently, a subset of training data items may be extracted from the set of retrieved training data items based on the generated scores that exceed a predefined threshold. In some instances, the score is generated by the compressor model prior to performing compression.

Once the compressor and generator models are trained, an inference query may be received. In response to the inference query, a set of data items may be retrieved from a data collection or knowledge source. Each retrieved data item may then be encoded at a given compression rate by appending a corresponding set of memory tokens and processed by the trained compressor model to generate compressed representations. In some examples, a score may be computed for each retrieved data item, either prior to or subsequent to compression, using the trained compressor model. The compressor model may thereby perform a re-ranking operation based on the computed scores to identify a subset of data items or compressed representations most relevant to the inference query. In certain aspects, the compressed representations associated with all retrieved data items or the re-ranked subset of the retrieved data items, together with the inference query, may be provided to the trained generator model to generate an inference response corresponding to the inference query.

In some instances, a query-dependent variation of the disclosed PISCO techniques may be leveraged in which retrieved data items may be compressed online and jointly with the inference query. More specifically, both the inference query and the retrieved set of data items (or top-k retrieved data items selected based on the scores) may be fed to the compressor model. Based on the inference query, the compressor model may effectively generate the compressed representations to promote information useful or relevant to answer the inference query. For this approach, the training pipeline is identical to query independent approach (as discussed above) except that now the inference query is also fed at compression time to the compressor model. In some examples, the query-dependent PISCO techniques may only work in online mode.

In some instances, each data item within the data collection or knowledge base may be encoded with the given compression rate and subsequently, by using the trained compressor model associated compressed representations may be generated for each encoded data item. These compressed representations may be stored in an embedding database for an efficient retrieval during inference. Once the embedding database has been maintained, one or more inference queries may be received. In some aspects, techniques are disclosed supporting an offline inference mode where for each received inference query, a set of relevant data items may be identified and associated set of compressed representations may be retrieved from the embedding database. In some examples, the score may be computed and assigned to the set of compressed representations associated with a relevant data item to identify a subset of (e.g., top-k) relevant data items, thereby enabling further reductions in inference time. In some aspects, the inference answer may be generated based on the inference query and the retrieved compressed representations associated with the subset of relevant data items or the set of relevant data items. In some examples, the re-ranking is performed based on a predefined criterion.

In some embodiments, a system is provided that includes one or more data processors and a non-transitory computer readable storage medium containing instructions which, when executed on the one or more data processors, cause the one or more data processors to perform part or all of one or more methods disclosed herein.

In some embodiments, a computer-program product tangibly embodied in a non-transitory machine-readable storage medium, including instructions configured to cause one or more data processors to perform part or all of one or more methods or processes disclosed herein.

In some embodiments, a system is provided that includes one or more means to perform part or all of one or more methods or processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

The present disclosure is described in conjunction with the appended figures:

FIG. 1 is a block diagram illustrating an overview of pretty simple compression (PISCO) training based on sequence-level knowledge distillation in accordance with some aspects of the present disclosure.

FIG. 2 illustrates a query-independent or offline deployment of PISCO-based retrieval-augmented generation (RAG) in accordance with some aspects of the present disclosure.

FIG. 3 illustrates a query-dependent and/or online deployment of the PISCO-based RAG in accordance with some aspects of the present disclosure.

FIG. 4 shows an average accuracy for the PISCO-based RAG leveraging Mistral-7B as backbone model with different compression rates in accordance with example implementations of the present disclosure.

FIG. 5A illustrates an exemplary prompt to evaluate performance of in accordance with example implementations of the present disclosure.

FIG. 5B illustrates pairwise comparison results using generative pre-trained transformer 4 omni (GPT-40) using the sample prompt of the FIG. 5A.

FIG. 6 illustrates exemplary results showing an impact of different teacher models on PISCO techniques in accordance with example implementations of the present disclosure.

FIG. 7 illustrates an impact of increasing number of documents on accuracy of the Solar model with and without PISCO techniques in accordance with example implementations of the present disclosure.

FIG. 8 illustrates an exemplary flowchart of the disclosed PISCO-based RAG techniques in accordance with some aspects of the present disclosure.

### DETAILED DESCRIPTION

The present disclosure discloses embodiments relating to an enhanced retrieval-augmented generation (RAG) pipeline by efficiently compressing retrieved contexts into compact embeddings (or compressed representations) to improve latency or throughput of RAG. More specifically, techniques are provided for training and deploying large language models (LLMs) in the RAG pipeline for generation of compressed representations (or vector representations) of the retrieved contexts corresponding to a user question (or query). According to some embodiments, a technical solution is provided in the present disclosure to a technical problem of improving speed and thus scalability of RAG systems while maintaining good accuracy of generated responses.

In some embodiments of the present disclosure, pretty simple compression (PISCO) techniques are disclosed to improve RAG. For instance, given a user question, a traditional RAG system may retrieve passages or documents from one or more datastores (or databases) that are relevant to the user question by using a document retriever. After that, an LLM is used to generate an answer based on the user question and the retrieved passages. According to the disclosed techniques, PISCO may compress the retrieved passages into compressed representations (or vector representations), and an LLM may generate an answer based on the user question and the compressed representations of the retrieved passages. The length of the compressed representations may be orders of magnitude smaller than the length of the retrieved passages and thus a substantial speed-up in response generation by a RAG may be achieved, while maintaining similar accuracy as compared to the traditional RAG.

In some aspects of the present disclosure, PISCO techniques may employ two LLMs, a compressor model and a generator model (or a decoder LLM). The compressor model is used to produce compressed representations, and the generator model is used to generate the answer. In some instances, both LLMs may be modifications of a same base LLM (or a backbone LLM). In some other instances, both LLMs may correspond to a different base LLM. Examples of the base LLM (or the backbone LLM) may include but are not limited to HyperClovaX, Claude, LLaMa, Mistral, Solar. Both LLMs (the compressor model and the generator model) may have a separate set of learnable adapters (e.g., LoRA adapters) for fine-tuning the compressor model and the generator model.

Further, the PISCO techniques may utilize soft compression techniques to reduce the context length of retrieved documents (or passages). The soft compression techniques may comprise replacing each retrieved document in a prompt for the generator model with compressed representations (i.e., a few vectors in the embedding space). The soft compression techniques are in contrast with hard compression approaches, which replace documents with a summary composed of actual tokens (e.g., by extracting key sentences in the document). Based on example implementations, the disclosed approaches (PISCO) are able to achieve a high compression rate, for example, 16 times compression of retrieved documents with minor loss in accuracy (e.g., 0-3%) across a wide range of question answering datasets, covering multiple domains.

According to present disclosure, a pre-training of both the compressor model and the generator model performed using auxiliary tasks such as autoencoding (AE) or text continuation from a compressed representation may be avoided. Moreover, annotated data (or labeled data) is also not needed for the PISCO. The PISCO techniques avoid pre-training and rely on sequence-level knowledge distillation (SKD) to train both the LLMs and hence achieve reduced training time.

Furthermore, both the LLMs (the compressor and the generator) may potentially be trained using only unlabeled data via sequence-level knowledge distillation (where ground truth labels are generated by a teacher LLM during training). During the training process, an off-the-shelf document retriever may be used to retrieve relevant documents from the database(s) based on a query (or question) of a user. Document retriever may include a re-ranker comprising a ranking LLM to perform re-ranking of retrieved documents. In the context of information retrieval, the term “re-ranking” may refer to a process of reordering a list of documents based on a specific criteria or models to improve the relevance or quality of the outcomes. The document retriever may output top-k documents among the retrieved documents based on the scores assigned by the ranking LLM (or re-ranker). In the distillation process, a teacher LLM may be employed that takes a query and uncompressed documents as input and generates an answer as output. The teacher LLM may comprise any backbone LLM. The teacher LLM may be leveraged to produce a reference response (or annotation) based on the query and uncompressed (top-k) retrieved documents.

During the training process, the learnable adapters (e.g., LoRA adapters) in the compressor model and the generator model are updated (or trained) to minimize a loss function. For example, a cross-entropy loss may be computed between answers generated by the teacher LLM and responses (or predictions) generated by a composition of the compressor model and the generator model. For each query, the generator model generates the responses (or predictions) based on the query and the compressed representations (generated by the compressor model) of the top-k retrieved documents corresponding to the query.

After the training of the compressor model and the generator model, the performance of the disclosed RAG pipeline may be evaluated on various question answers (QA) based datasets and by using the evaluation metric “match”. In sequence-level matching, for a given label (annotation or answer) and a prediction (or response), a “match” is defined as ‘1’ if a normalized label is found within a normalized prediction and ‘0’ otherwise. Normalization may include converting the label or prediction into lowercase letters, removing articles ‘a’, “an”, “the”, and the like. In the present disclosure, the “training of the generator model” is also referred herein as “fine-tuning the generator model”. Also, the terms “generator model” and “decoder LLM” are used interchangeably in the present disclosure.

In some instances, once the compressor model and the generator model are trained (or fine-tuned), the compressor model may be deployed to process or compress all the documents of the database(s) or the datastore(s). To avoid compression time during inference, large corpora or the available documents may be preprocessed into compressed representations and may be stored using less memory in an embeddings database. The compression may be performed independent of the query. During inference, the document retriever may retrieve the compressed representations from the embeddings database based on a given query.

In some instances, the compressed representations may be used to perform the re-ranking operation. Another re-ranker may be built or trained that may score or grade the compressed representations based on the query. The re-ranking operation based on the compressed representations may take much less time due to limited or short context size as compared to the retrieved documents. By reducing the cost (i.e., time) of the re-ranking operation, the total inference time of the RAG pipeline may be improved.

According to some aspects of the present disclosure, the compressor model may also be utilized to perform re-ranking operation. Traditionally, the document retriever employs another language model (or the ranking LLM) to process each document of the retrieved documents and generates a score based on a relevance of the document to the query. The processing cost (i.e., time) of the re-ranker (e.g., the ranking LLM inside the document retriever) is a function of the document length. By using the PISCO framework, the compressor model may enable compressing the documents into N memory tokens, with N being significantly smaller than the initial document length. Hence, processing compressed documents (or document embeddings) is much faster than processing the corresponding documents or original textual representations. In order to train a re-ranker based on the compressed representations, a set of training documents (or list of documents) may be compressed with a PISCO compressor model. Afterwards, each document may be replaced by its compressed representation, and the PISCO compressor may be trained for the re-ranking task (via a state-of-the-art re-ranking training strategy) by using the query and the compressed document (instead of the textual representation) as inputs.

In some other instances, the compressor model may be utilized at run-time during inference. To reduce the effect of compression time on the overall RAG efficiency or throughput, in some instances, only an incomplete subset of layers of the compressor model may be used. The incomplete subset may include, for example, the output of intermediate layers used as the compressed representation. This makes compression faster while still maintaining good performances, for instance, a −1% to −2% drop in accuracy may be observed by using only 20% of the original model layers (i.e., the compressor model). This enables the online use of the PISCO technique, e.g., compressing the documents on-the-fly at run-time, and still being fast due to a quadratic cost of the inference of transformer-based models. Moreover, the online deployment of the compressor model may eliminate the need for large storage (e.g., embeddings database(s)) for pre-computed compressed representations (e.g., as in query independent offline deployment scenario discussed above).

In some embodiments, a query-dependent variation of the PISCO techniques may be leveraged in which documents may be compressed online and jointly with the query. More specifically, both the query and the retrieved documents (or top-k retrieved documents) may be fed to the compressor model. Based on the query, the compressor model may effectively generate the compressed representations to promote information useful or highly relevant to answer the query. These query-dependent PISCO techniques may offer even higher compression rates with similar results or accuracy. For this approach, the training pipeline is identical to query independent approach (as discussed above) except that now the query is also fed at compression time to the compressor model. The query-dependent PISCO techniques may only work in online mode.

Furthermore, the query-dependent variation of the PISCO techniques may use a compressor model that is trained jointly to predict the compressed representations of documents relevant to the query and also predict a score (or grade or rank) of the document with respect to the query (as classically done in RAG pipelines). Thus, in some instances, generation of compressed representations and re-ranking operation may be performed concurrently.

It may be appreciated that the techniques disclosed herein provide several technical advantages for improving retrieval-augmented generation (RAG) systems. For example, the PISCO techniques, which employ soft or hard compression of retrieved documents into compact vector representations, may substantially reduce the input context length, thereby improving the inference latency and throughput of the RAG pipeline. In addition, the disclosed architecture utilizes the compressor language model (LM) and generator LM with separate sets of fine-tunable adapters (such as LoRA), providing flexibility and modular optimization. This enables efficient specialization of each model for compression or generation tasks while avoiding retraining of the underlying base models. Furthermore, the disclosed training techniques involving sequence-level knowledge distillation may eliminate the need for pre-training or labeled data, thereby reducing training cost and time while maintaining competitive performance by learning directly from teacher-generated responses. Similarly, an offline mode utilizing pre-computed compressed representations may reduce runtime compression overhead and storage requirements through compact embeddings, whereas an online mode employing partial layers of the compressor LM may enable query-dependent, on-the-fly compression with lower computational cost and memory footprint, while incurring only marginal accuracy loss (e.g., less than 3%).

Since the disclosed compression techniques employing the compressor language model (LM) do not require reconstruction of original tokens from compressed embeddings (as is typically required in autoencoder-based methods), these disclosed techniques enable more aggressive dimensionality reduction (or higher compression rates) of the embeddings associated with the retrieved context. Through such higher compression rates, a larger portion of the context may be processed by the language models, thereby improving the accuracy of the generated responses for a given query. Accordingly, the techniques disclosed herein, such as the PISCO techniques, provide a simple yet effective approach to train and deploy an efficient RAG pipeline while maintaining high response quality. The present disclosure thus provides a technical solution to the technical problem of context compression in RAG systems, enabling improved scalability along with faster and more efficient retrieval.

While various aspects and embodiments disclosed herein describe the use of PISCO techniques primarily in the context of text-based RAG systems utilizing language models, the same techniques are broadly applicable to any generative AI architecture that relies on retrieval of external context to generate an output. More specifically, any architecture that combines retriever components may benefit from context compression by leveraging the disclosed PISCO techniques. The compression mechanisms operate at level of latent representations or embeddings, making it inherently modality-agnostic. In accordance, the disclosed techniques may process retrieved context of various types (e.g., text, image, audio, video, or a mixed-modality data corresponding to any combination thereof) in response to queries that may likewise be associated with a single modality (e.g., text or image) or multimodal combinations thereof (e.g., text and image).

During training, a modality-appropriate teacher model (depending on the application domain) may be employed to generate target outputs for knowledge distillation. For instance, for image-based or multimodal RAG pipelines, teacher models such as Flamingo, Gemini, or GPT-4V may generate corresponding reference images, captions, or text-image pairs conditioned on the full uncompressed context. For audio-based RAG pipelines, teacher models such as Whisper, AudioLM, or AudioPaLM may generate transcriptions, embeddings, or audio representations based on the complete audio context. Similarly, for text-based RAG pipelines, teacher models such as Mistral-7B, GPT-4 or PaLM may provide reference text outputs. A modality-appropriate compressor model and a modality-appropriate generator model may then be jointly trained using sequence-level knowledge distillation. In this process, the compressor model learns to produce compressed, query-relevant embeddings of the retrieved context, whereas the generator model learns to generate or reconstruct target outputs associated with the teacher model conditioned on the compressed embeddings and the query. The loss function may include cross-entropy, cosine similarity, or perceptual similarity metrics depending on the modality or application domain.

For example, in image-based RAG pipelines, a compressor model may receive a retrieved set of reference images (e.g., product images or diagnostic scans) and encode each image into compressed representations, such as low-dimensional visual embeddings. A generator model may then generate an output image conditioned on a user query, which may be text-based, image-based, voice-based, or a combination of multiple modalities, and the corresponding compressed representations of the retrieved images. In some instances, both the compressor and generator models may be fine-tuned adaptations of the same base model (or backbone model), while in other instances, these may correspond to different base models; the differentiation in functionality may be achieved via separate sets of learnable adapters (e.g., LoRA) for each model. Examples of base or backbone models may include CLIP, BLIP, or Flamingo for image-based pipelines, Whisper, Wav2Vec, or AudioLM for audio-based pipelines, and Flamingo, GPT-4V, or BLIP-2 for multimodal text-image pipelines. These approaches enable modular fine-tuning while maintaining a shared latent space that connects the compressor and generator for efficient cross-modal reasoning and generation.

In such implementations, both the user query and the retrieved context are represented within a shared multimodal latent space, enabling semantic alignment across modalities and facilitating coherent, contextually relevant generation. By replacing high-dimensional features with compressed representations, inference speed and memory utilization may be significantly improved while maintaining perceptual quality.

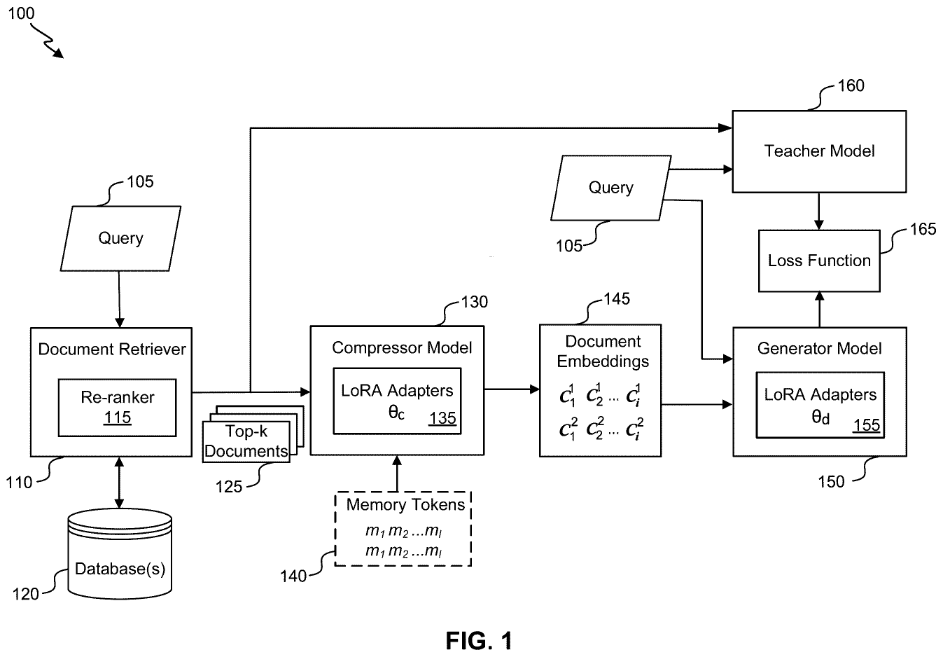

FIG. 1 is a block diagram illustrating an overview of pretty simple compression (PISCO) training based on sequence-level knowledge distillation in accordance with some aspects of the present disclosure. The FIG. 1. shows an exemplary training pipeline 100 of PISCO-based RAG framework where each query q 105 may be augmented with a set of relevant documents (d₁, . . . , dₖ>) 125 retrieved from a large database 120 of documents D. For improved performance, this technique may involve two processes: first, a document retriever 110 may identify an initial pool of relevant documents, and then a re-ranker 115 may refine and prioritize the k most relevant documents. In traditional RAG, a final response F is generated by prompting a language model [symbol] (e.g., 160) with both the query 105 and the set of retrieved documents.

In general, the accuracy of the response generated improves as the number of documents increases. However, since documents tend to be longer than queries and the computational complexity of transformer-based models scales quadratically with the context length (e.g., the set of retrieved documents). Thus, increasing the number of documents or context size may make generation computationally expensive and cause delays. Accordingly, a soft compression model may be used to address the context size and delays problem by mapping each document dᵢ into a shorter set of embeddings or a key-value (K/V) cache, cᵢ. The generation process may then be conditioned on the compressed representations F as in equation 1.

$$F ∼ ℱ ( . \vert q , {c}_{1} , … , {c}_{k} ) \qquad Equation 1$$

According to disclosed techniques, PISCO may involve a compressor (e.g., compressor model 130) and a decoder model (e.g., generator model 150). For compression, a set of l memory tokens 140 (m₁ . . . , mₗ) is appended to each document dᵢ and the corresponding prompt (dᵢ; m₁ . . . , mₗ) is passed through the compression model [symbol] _{θ}_{_{c}}. The l final hidden states, corresponding to the memory tokens 140, may be extracted to form the document embeddings

$${c}_{i} = {( {c}_{i}^{s} )}_{s = 1 , … , l} .$$

Each document may be encoded into l vectors, each sharing the dimension of the encoder's embedding space, [symbol] . The number of tokens l effectively controls the compression rate. The memory tokens 140 (m₁ . . . , m₁) may be optimized jointly with the LoRA adapters θ_{c} 135. During optimization, the compression model [symbol] _{θ}_{_{c}} is encouraged via the distillation objective described below to encode information about the compressed document.

Decoding may be carried out using the language model [symbol] (the generator model 150) with a separate set of LoRA adapters θ_{d} 155. Fine-tuning the decoder (or the generator model 150) may facilitate the decoder to adapt its interactions with the compressed representations (or document embeddings 145) depending on the query 105. Additionally, this fine-tuning process may not tend to compromise the ease of setting up PISCO, as end-to-end fine-tuning may be completed, for example, in only a day for 7B-10B (billion) parameters model on a single high-end GPU.

Further, sequence-level knowledge distillation may be utilized to train PISCO models, where large teacher models are used to train smaller under-parameterized student models. The distillation approach works well may be due to an invariance principle that language models should give the same answers whether their input is compressed or not. For distillation, labels or annotations may be generated by a teacher model 160.

Specifically, given a query q 105, let (a₁ . . . , aᵣ) represent the tokens generated by the teacher LLM ( [symbol] ) 160 based on the top-k documents 125 (d₁, . . . , dₖ>) and the query (q) 105 and previously generated tokens a_{<i}=(a₁ . . . , aᵢ₋₁):

$${a}_{i} ∼ 𝒯 ( . \vert {d}_{1} , … , {d}_{k} , q , {a}_{< i} ) . \qquad Equation 2$$

The training objective ( [symbol] ) on the model parameters θ_{c} and θ_{d} associated with the compression LLM and decoder (or generator) LLM 150, respectively may be the cross-entropy loss computed on the decoder (or the generator model 150) conditioned on the document embeddings 145 and the query 105. An exemplary loss function 165 is represented in equation 4.

$${c}_{i} = {( {c}_{i}^{s} )}_{s = 1 , … l} = {ℱ}_{{θ}_{c}} ( {d}_{i} , {m}_{1} , … , {m}_{l} ) \qquad Equation 3$$

$$ℒ ( {θ}_{c} , {θ}_{d} ) = - {\sum }_{i = 1}^{r} log {ℱ}_{{θ}_{d}} ( {a}_{i} \vert q , {c}_{1} , … , {c}_{k} , {a}_{< i} ) \qquad Equation 4$$

It may be appreciated that the labels generated by the teacher model 160, (a₁ . . . , aᵣ), may be pre-computed and re-used across different training runs, thereby reducing training cost and improving efficiency. In the compression framework, each document dᵢ may be processed along with a set of learnable memory tokens (m₁, . . . , mₗ) by a compressor model [symbol] _{θ}_{_{c}} to produce compressed representations

$${c}_{i} = {( {c}_{i}^{s} )}_{s = 1 , … , l} ,$$

as given in Equation 3. The generator model [symbol] _{θ}_{_{d}} may be then trained to predict the teacher-generated tokens conditioned on the query q, the compressed representations c₁, . . . , cₖ, and previously generated tokens a_{<i} as given in Equation 4. While the formulation above in Equation 3 and Equation 4 is presented for text-based RAG, it may be readily extended to image-based, audio-based, or multimodal compression pipelines, where dᵢ, corresponds to an image, audio, or a combination of modalities, and the learnable memory tokens (m₁, . . . , mₗ) are appended to the input for capturing the information in a compact latent space suitable for downstream generation tasks by applying the compression model [symbol] _{θ}_{_{c}}.

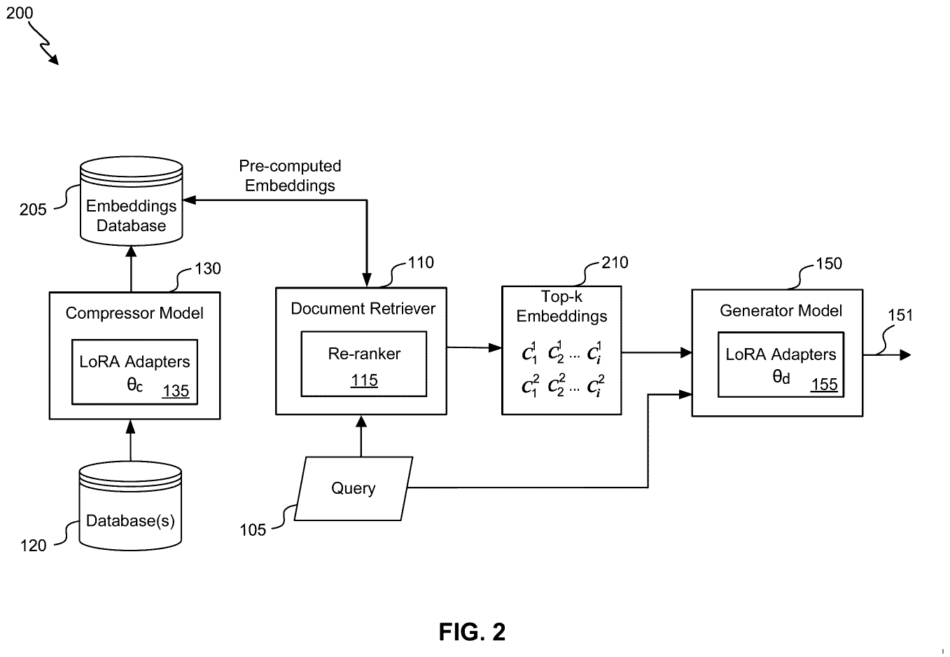

FIG. 2 illustrates an exemplary overview of query-independent or offline deployment 200 of PISCO-based retrieval-augmented generation (RAG) in accordance with some aspects of the present disclosure The compressor model 130 may pre-process each of the documents in the database 120 to generate a compressed representation independent of the query 105. The compressed representations may be stored in an embeddings database 205. Afterwards, when a (new or inference) query 105 is received by the document retriever 110, pre-computed embeddings relevant to the query 105 may be retrieved from the embeddings database 205. The document retriever 110 may also use re-ranker 115 to select top-k embeddings 210. Now as the re-ranker 115 assigning scores to the compressed representations instead of retrieved documents, therefore, the re-ranker 115 may be a simple language model and may generate scores fast as compared to re-ranking operation on documents of the database 120. The generator model 150 may generate an answer based on the query 105 and the top-k embeddings 210. In an embodiment, the query 105 may be received from a user interface (e.g., one or more of a display, a keyboard, a mouse, a microphone, and a speaker, or a user interface may be represented by prompt), and the answer 151 may be output to the user interface. In an embodiment, the document retriever 110, the compressor model 130, and the generator model 150 may be stored in a memory of the PISCO RAG system of FIG. 2, which may operate locally with the user interface (e.g., on the same device) or remote (e.g., on separate devices communicating via a network) from the user interface.

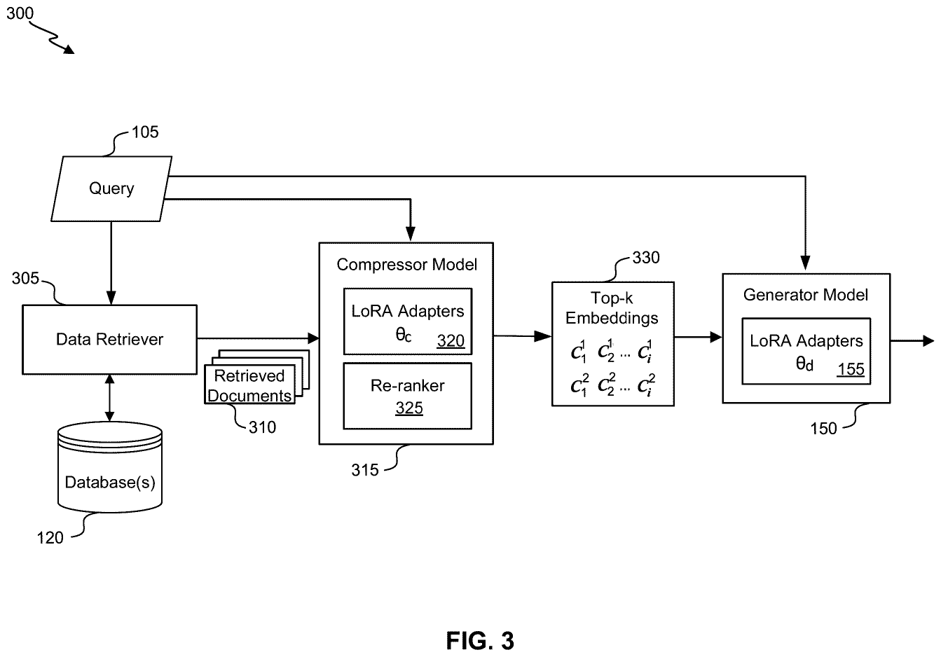

FIG. 3 illustrates a query-dependent and/or online deployment 300 of PISCO-based RAG in accordance with some embodiments of the present disclosure. In online deployment 300, the retrieved documents 310 (or top-k retrieved documents) may be compressed at first to generate document embeddings or top-k embeddings 330. Then, the generator model 150 may be leveraged to generate an answer by using top-k embeddings 330 and the query. In some instances, a ranking operation may be performed by the document retriever 110. In other instances, the ranking operation may be performed at the compressor model 315 by incorporating (via training) a re-ranker 325 in the compressor model 315. For online deployment 300, an intermediate representation (output of intermediate layers of the compressor model) may be considered as the compressed representation of an input document. This may reduce the time that may be consumed for the compression for each query 105. In an embodiment, the query 105 may be received from a user interface, and the answer may be output to the user interface. In an embodiment, the document retriever 110, the compressor model 315, and the generator model 150 may be stored in a memory of the PISCO-based RAG system of the FIG. 3, which may operate locally (e.g., on the same device) with the user interface or remote (e.g., on separate devices communicating via a network) from the user interface.

In some embodiments, a data retriever 305 may be employed that only retrieves the relevant documents from the database 120 based on the query 105. The compressor model 315 may be trained by using the same training pipeline as discussed in the FIG. 1, except that now the query 105 is also provided at the compressor model 315. The compressor model 315 may be trained jointly to perform compression based on the query 105 and the ranking of the retrieved documents 310. The re-ranker 115 of the document retriever 110 may use another model (or LLM) to do the ranking task. By performing ranking along with compression, inside the compressor model 315, may save a lot of time. Moreover, in the query-dependent online deployment 300, the compressor model 315 can generate improved vector representations by placing greater emphasis on the portions of the context that are most relevant to answering the query 105.

### Examples

Example implementations of the disclosed techniques to achieve faster and yet accurate RAG pipelines are provided by utilizing various backbone LLMs such as Mistral-7B-Instruct, Llama-3.1-8B-Instruct, and SOLAR-10.7B-Instruct. PISCO with different backbone LLMs were used to evaluate the performance. The training dataset comprised 453,000 questions sourced from documents within the Wikipedia KILT dataset. The documents were preprocessed into chunks of 128 tokens. These documents collectively served as the database 120 for training. For each question, the top-k documents (k=5) were retrieved and processed by the teacher model 160 (or teacher LLM) to generate labels. These labels were used in sequence-level knowledge distillation. Each document was compressed into l embedding vectors, where I was predetermined or fixed for each PISCO model. PISCO models that configured a compression rate of 16 utilized 8 embeddings per document. Training of the models and evaluations were performed using the Bergen library.

After training, the PISCO models were evaluated on general knowledge questions answering (QA) tasks from the datasets including Natural Questions, TriviaQA, HotpotQA, ASQA, and PopQA. Accuracy is used as the main evaluation metric which is also called “match” in the QA context. Accuracy is defined as 1 if the normalized label is found within the normalized prediction and 0 otherwise.

TABLE 1
Performance accuracy of PISCO models on general domain QA with 5 retrieved documents.

| | | | | | | |
|---|---|---|---|---|---|---|
| Compression | | | | | | |
| Rate | ASQA | HotpotQA | NQ | TriviaQA | POPQA | Average |

Decoders with no compressions

| | | | | | | | |
|---|---|---|---|---|---|---|---|
| Mistral-7B | — | 0.74 | 0.51 | 0.69 | 0.92 | 0.70 | 0.71 |
| Llama-3.1-8B | — | 0.71 | 0.50 | 0.65 | 0.90 | 0.68 | 0.69 |
| Solar-10.7B | — | 0.75 | 0.55 | 0.71 | 0.93 | 0.71 | 0.73 |

Compression Models

| | | | | | | | |
|---|---|---|---|---|---|---|---|
| PISCO - MistralΔ | x16 | 0.72 | 0.48 | 0.65 | 0.90 | 0.66 | 0.68 |
| PISCO - Mistral (x128) | x128 | 0.68 | 0.46 | 0.61 | 0.89 | 0.55 | 0.64 |
| PISCO - Llama | x16 | 0.72 | 0.50 | 0.64 | 0.91 | 0.66 | 0.69 |
| PISCO - Solar | x16 | 0.78 | 0.57 | 0.70 | 0.94 | 0.71 | 0.74 |

Performance results of various PISCO models in comparison with the backbone LLMs are presented in Table 1. All the PISCO models with the compression rate 16 show similar or comparable performance (0-3%) to the corresponding uncompressed backbones. Notably, PISCO-Solar outperforms Solar (backbone LLM), showing that the compression may have a de-noising effect, discarding irrelevant information. By changing the number of memory tokens l prompted to the compressor model 130, models with different compression rates may be trained.

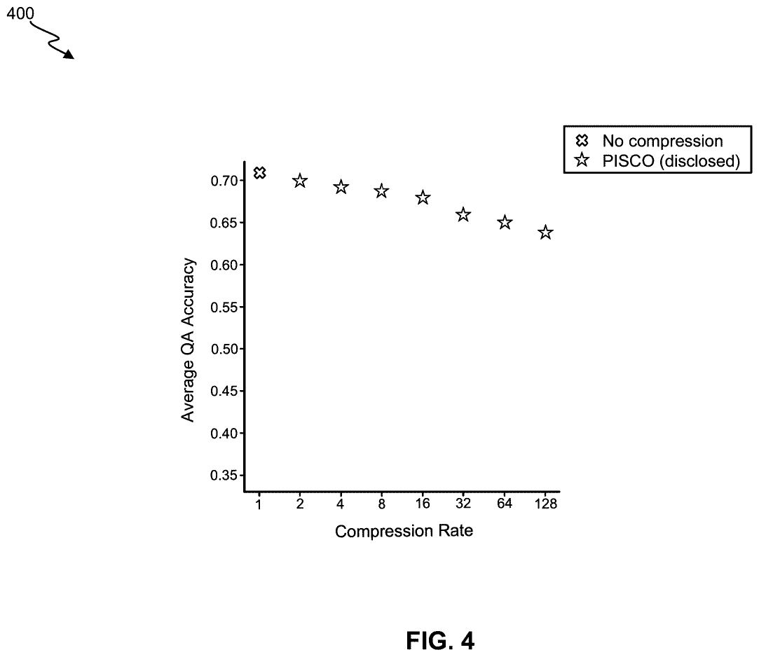

FIG. 4 shows exemplary results 400 illustrating an average accuracy for the PISCO-based RAG leveraging Mistral-7B as backbone model with different compression rates in accordance with example implementations of the present disclosure. FIG. 4 shows an average accuracy for with compression rates between ×2 and ×128. Performance decreases gradually as the compression rate increases up to 16, after which the decline becomes more pronounced. Mistral-7B LLM was used as the backbone LLM. The PISCO-Mistral models with compression rate up to 16 exhibit average QA accuracy similar or slightly reduced (1%-2%) than the backbone model (that uses uncompressed documents).

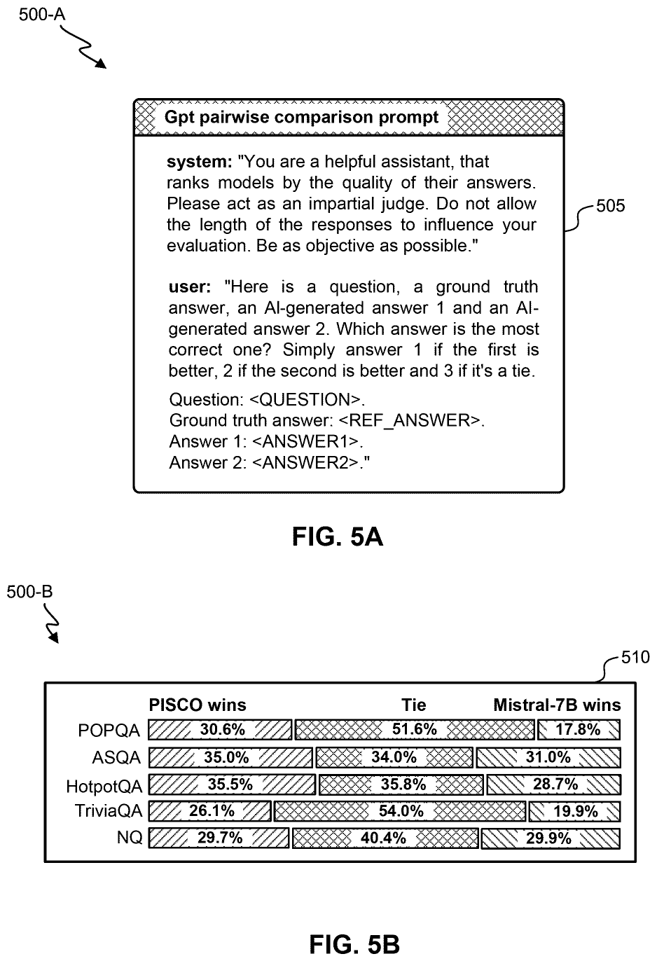

FIG. 5A illustrates an exemplary prompt 500-A to evaluate performance of PISCO-based RAG framework in accordance with example implementations of the present disclosure. FIG. 5B illustrates pairwise comparison results 500-B using GPT-40 and which in one embodiment may be performed using the exemplary prompt 500-A shown in the FIG. 5A to the GPT-40 model. GPT-40 was used due to its strong ability to assess semantic content to perform pairwise comparisons between generated answers to compare models. To enable precise comparison of answers generated by different methods beyond the accuracy metric, the GPT-40 model was employed and the exemplary prompt 500-A was used to instruct the GPT-40 model. Assessments were conducted using GPT-40-2024-11-20. To limit costs, only 1000 samples were selected for evaluation from each dataset. To reduce positional bias, the positions of the answers within evaluation prompt were randomly altered during comparison process. The GPT results 510 in FIG. 5B shows that PISCO-Mistral outperforms the Mistral-7B backbone model with respect to accuracy.

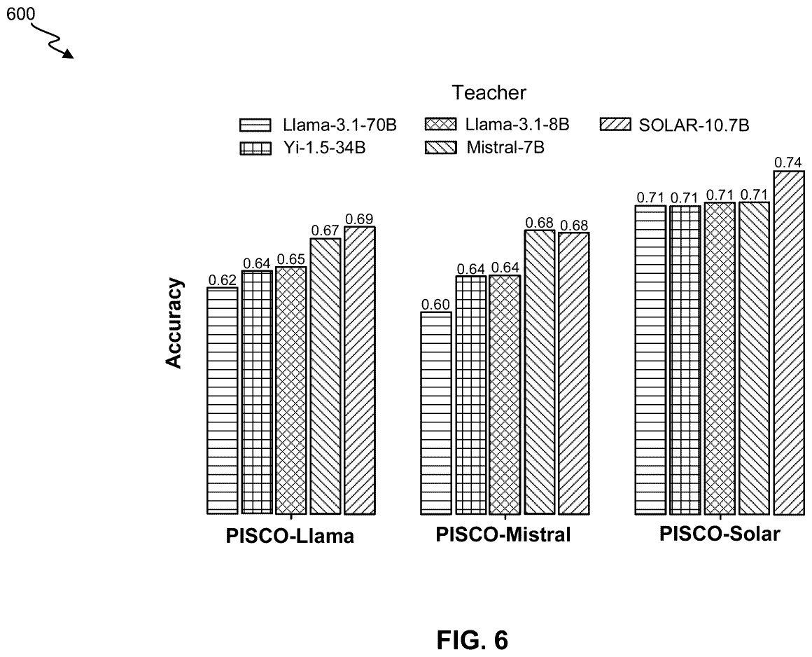

FIG. 6 illustrates exemplary results 600 showing an impact of distinct teacher LLMs on PISCO technique in accordance with example implementations of the present disclosure. To further investigate the influence of teacher LLMs, PISCO models were trained using various teacher models. Average accuracy of each of the PISCO models on general domain QA tasks was evaluated, with results shown in FIG. 6. Interestingly, the best-performing teachers are generally Mistral-7B or Solar-10B models and not the stronger or bigger models (e.g., Yi-1.5-34B, or Llama-3.1-70B). A manual analysis of the labels for each teacher indicates that these models often include justifications for their answers based on the given contexts. Thus, training the PISCO models to replicate this reasoning process may account for the observed performance improvements. Moreover, the PISCO-Solar models are robust across all teachers.

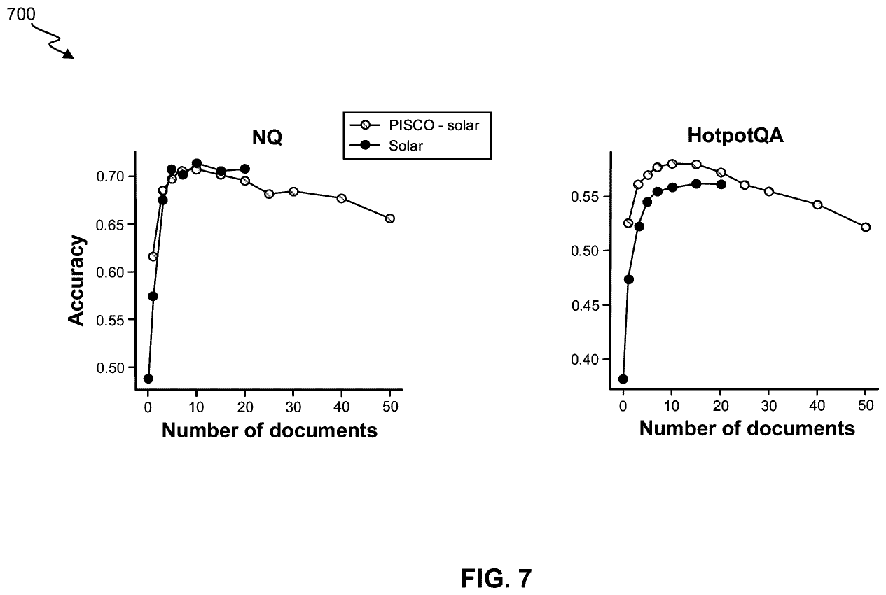

FIG. 7 illustrates exemplary results 700 showing an impact of increasing number of documents on accuracy of the Solar model with and without PISCO techniques in accordance with example implementations of the present disclosure. To assess capability of PISCO models in managing large-scale document inputs, inference was conducted using PISCO-Solar model on document sets ranging from one to fifty documents. The evaluation was performed on natural questions-NQ (the left image) and HotpotQA (the right image) datasets and results are shown in FIG. 7. The base model Solar's performance is constrained by a 4096-token context length, limiting Solar's capacity to process approximately 20 documents concurrently to generate an answer for a query. The PISCO-Solar model maintained its performance closely aligned with the base model Solar while handling up to 20 documents. Beyond 20-documents threshold, a gradual decline in performance is observed in PISCO-Solar, which is a common trend in RAG models. Performance degradation may be mitigated by increasing the value of parameter k (i.e., number of documents retrieved for each query). Notably, current experimental setup employs k=5 documents during training. Therefore, the results highlight the robustness of the PISCO-Solar model in handling extensive document sets as compared to Solar. Furthermore, modifications to fine-tuning parameters, like increasing k, may address performance limitations associated with larger document volumes.

Additional details concerning the present description are set forth in Attachment 1. As noted in Attachment 1, with ×16 compression, PISCO models advantageously achieve a 5.7× inference speed-up.

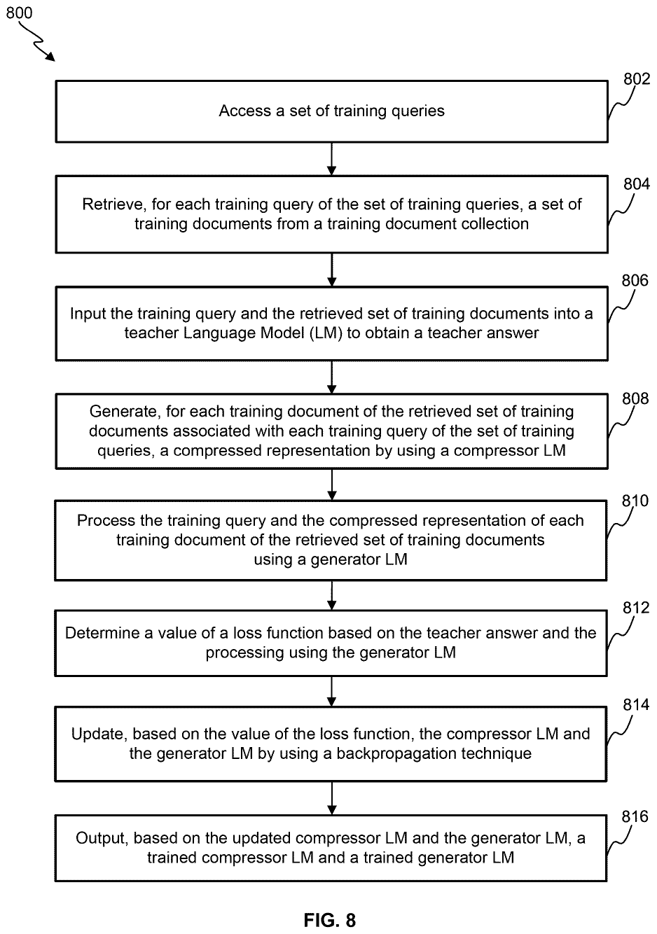

FIG. 8 illustrates an exemplary flowchart 800 of the disclosed techniques for training PISCO-based RAG framework in accordance with some aspects of the present disclosure. In at least one exemplary implementation, pretty simple compression (PISCO) techniques are provided for training and deploying language models to improve RAG pipeline. Accordingly, compressed representations (or embeddings) of retrieved context or passages may be generated corresponding to a user query (or question). For training PISCO-based RAG framework, a set of training queries associated with a given modality may be accessed at block 802. For example, a training query may be provided as a textual prompt, although in other applications the training query may also be image-based, audio-based, or multimodal, depending on the modality supported by the underlying RAG system. For each training query, a corresponding set of training documents may be retrieved from a training document collection at block 804.

At block 806, the set of training queries and the retrieved set of training documents (context) may be processed by a teacher model 160 (or teacher language model) to produce a teacher output (e.g., a textual answer or sequence continuation). For each retrieved training document, a compressed representation may be generated by leveraging a compressor model 130 (or compressor language model), at block 808, that is configured to reduce a length of a retrieved training data item while retaining query-relevant information. At block 810, a training query along with compressed representations of the corresponding training documents may be processed by a generator model 150 (or generator language model) that, based on the provided input, is configured to generate a predicted output corresponding to the training query. Both the generator model 150 and the compressor model 130 may be trained by determining a loss function 165, at block 812, based on a difference between the teacher output and the predicted output generated by the generator model 150.

The training may involve updating (parameters of) these models through a backpropagation technique, at block 814, that is guided by sequence-level knowledge distillation in which the loss function 165 is determined over the entire output sequence rather than on a token-by-token basis. Once the training is completed, a trained compressor model and a trained generator model are obtained, at block 816, that were jointly trained such that the trained generator model is capable of reconstructing teacher-quality outputs from compressed, query-specific representations generated by the trained compressor model for the corresponding retrieved set of training documents.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The disclosed embodiments provide a technical solution to the technical problem of performing natural-language inference on large document collections using limited computational resources. The system implements a structured RAG pipeline that transforms unstructured document data into specialized, compressed intermediate representations generated by a compressor language model (LM). These compressed representations constitute non-conventional computer data structures that reduce computational load and memory usage, enabling the generator LM to produce inference answers more efficiently than conventional systems. In certain embodiments, the disclosed system implements dedicated processor circuitry, memory hierarchies, network interfaces, and machine-learning accelerators that operate in a particular arrangement to perform the RAG operations described herein. The system's execution of retrieval, compression, and generation stages produces a concrete, tangible output, an inference answer, generated through a hardware-implemented transformation of retrieved document data.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol.

Instructions may be executed by one or more processors, such as one or more digital signal processors, general purpose microprocessors, application specific integrated circuits, field programmable gate arrays, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding or incorporated in a combined codec. Also, the techniques could be fully implemented in one or more circuits or logic elements.

The techniques of this disclosure may be implemented in a wide variety of devices or apparatuses, including an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification, and variation of the concepts herein disclosed may be resorted to by those skilled in the art, and that such modifications and variations are considered to be within the scope of this invention as defined by the appended claims.

Although specific aspects have been described, various modifications, alterations, alternative constructions, and equivalents are possible. Embodiments are not restricted to operation within certain specific data processing environments but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations may be performed in parallel or concurrently (i.e., operations occurring within the same timeframe, potentially overlapping but not necessarily precisely at the same moment; e.g., a system adapted to execute multiple work units (e.g., threads) concurrently by using multiple physical processors, allowing for parallel execution of multiple processes where each processor may execute one or more threads, or by using a single (multi-threaded) process that divides work units into multiple smaller threads that may be executed concurrently within the single process). In addition, the order of the operations may be rearranged. The terms “first,” “second,” “third,” “fourth,” “fifth,” and “sixth” are naming conventions used so different items may be referred to separately and are not intended to convey an order or priority unless such order or priority is conveyed with other language. A process may have additional steps not included in the figure. Various features and aspects of the above-described aspects may be used individually or jointly.

The present description provides preferred exemplary embodiments only, and is not intended to limit the scope, applicability or configuration of the disclosure. Rather, the description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the following description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

1. A computer-implemented method comprising:
accessing a set of training queries;
for each training query of the set of training queries:
retrieving a set of training documents from a training document collection;
inputting a training query associated with the set of training queries and the retrieved set of training documents into a teacher language model (LM) to obtain a teacher answer;
generating, for each training document of the retrieved set of training documents, a compressed representation by using a compressor LM;
processing the training query and each of the compressed representation of each training document of the retrieved set of training documents with a generator LM;
determining a value of a loss function based on the teacher answer and the processing using the generator LM;
updating, based on the value of the loss function, the compressor LM and the generator LM by using a backpropagation technique; and
outputting, based on the updating of the compressor LM and the generator LM, a trained compressor LM and a trained generator LM;
wherein the compressor LM and the generator LM are trained based on sequence-level knowledge distillation.

2. The computer-implemented method of claim 1, wherein the generation of the compressed representation associated with each training document of the retrieved set of training documents with a given compression rate further includes:
appending a set of memory tokens to each training document of the retrieved set of training documents, wherein each training document is compressed into a number of memory token within the set of memory tokens that are appended to each training document, and wherein the number of memory tokens is smaller than an initial length of each training document.

3. The computer-implemented method of claim 2, wherein the given compression rate varies across different training documents of the retrieved set of training documents.

4. The computer-implemented method of claim 2, wherein the given compression rate varies in accordance with a size of a training document of the retrieved set of training documents.

5. The computer-implemented method of claim 1, wherein the teacher LM is used to jointly fine-tune the compressor LM and the generator LM, and wherein the fine-tuning includes updating a compressor adapter and a generator adapter.

6. The computer-implemented method of claim 1, wherein two or more of the teacher LM, the compressor LM, and the generator LM comprise a same backbone LM.

7. The computer-implemented method of claim 1, wherein each of the teacher LM, the compressor LM, and the generator LM comprises a different backbone LM.

8. The computer-implemented method of claim 1, wherein no pre-training is performed on the compressor LM and the generator LM.

9. The computer-implemented method of claim 1, wherein the compressor LM and the generator LM are trained based on the sequence-level knowledge distillation using unlabeled dataset, and wherein answers generated by the teacher LM are used as ground truth labels.

10. The computer-implemented method of claim 1, wherein the loss function is cross-entropy loss.

11. The computer-implemented method of claim 1, further comprising:
generating, based on the training query, a score for each training document of the retrieved set of training documents corresponding to the training query, wherein the score is assigned to each training document based on a degree of relevancy of the training document with the training query; and
selecting, based on the score of each training document, a subset of training documents from the retrieved set of training documents, wherein the score corresponding to each training document in the subset of training documents exceeds a threshold.

12. The computer-implemented method of claim 11, wherein the score is generated by the compressor LM.

13. The computer-implemented method of claim 1, further comprising:
receiving an inference query;
retrieving a set of documents from a document collection based on the inference query;
encoding each document of the retrieved set of documents with a given compression rate;
generating the compressed representation for each encoded document by using the trained compressor LM; and
inputting the inference query and the compressed representation of each document of the set of documents to the trained generator LM to obtain an inference answer.

14. The computer-implemented method of claim 1, further comprising:
receiving an inference query;
retrieving a set of documents from a document collection based on the inference query;
encoding each document of the retrieved set of documents with a given compression rate;
generating, based on the inference query, the compressed representation for each document of the set of documents by using the trained compressor LM; and
inputting the inference query and the compressed representation of each document of the set of documents to the trained generator LM to obtain an inference answer.

15. The computer-implemented method of claim 1, further comprising:
receiving an inference query;
retrieving a set of documents from a document collection based on the inference query;
encoding each document of the retrieved set of documents with a given compression rate;
generating, based on the inference query, the compressed representation for each document of the set of documents by using the trained compressor LM;
assigning, based on the inference query, a score to the compressed representation for each document of the set of documents by using the trained compressor LM, wherein the trained compressor LM is configured to perform a re-ranking operation;
selecting, based on the score, a subset of compressed representations; and
inputting the inference query and the subset of compressed representations to the trained generator LM to obtain an inference answer.

16. The computer-implemented method of claim 1, further comprising:
encoding each document of a document collection with a given compression rate;
generating the compressed representation for each encoded document of the document collection by using the trained compressor LM;
storing the compressed representation of each encoded document into an embeddings database;
receiving one or more inference queries;
identifying, for each inference query of the one or more inference queries and by using the document collection, a set of documents relevant to each inference query;
retrieving, for each inference query of the one or more inference queries, a set of compressed representations corresponding to the set of documents from the embeddings database; and
generating, for each inference query of the one or more inference queries, an inference answer by inputting the inference query and the set of compressed representations to the trained generator LM.

17. The computer-implemented method of claim 16, further comprising:
generating, based on the inference query, a score for each compressed representation of the set of compressed representations corresponding to the inference query, wherein the score is assigned to each compressed representation based on a degree of relevancy of the compressed representation with the inference query; and
selecting, based on the score of each compressed representation, a subset of compressed representations from the retrieved set of compressed representations, wherein the subset of compressed representations includes top-k compressed representations based on the score.

18. The computer-implemented method of claim 1, wherein the generator LM includes a generator adapter that adapts the generator LM to perform the generation, and wherein the updating of the generator LM updates the generator adapter.

19. The computer-implemented method of claim 1, wherein the compressor LM includes a compressor adapter that adapts the compressor LM to perform compression, and wherein the updating of the compressor LM updates the compressor adapter.

20. A computer-implemented method for retrieval-augmented generation (RAG), comprising:
receiving an inference query that is output from a user interface;
retrieving a set of documents from a document collection based on the inference query;
generating a compressed representation for each document of the set of documents by using a compressor language model (LM);
inputting the inference query and the compressed representation of each document of the set of documents to a generator language model (LM) to generate an inference answer; and
outputting the inference answer for display at the user interface.

21. The computer-implemented method of claim 20, wherein documents stored in the collection of documents are stored in the compressed representation by using the compressor language model (LM).

22. The computer-implemented method of claim 20, further including:
inputting the inference query and the compressed representation of each document of the set of documents to the compressor language model (LM) to obtain the inference answer.

23. The computer-implemented method of claim 20, wherein the compressor LM and the generator LM are trained based on sequence-level knowledge distillation using an unlabeled dataset.

24. The computer-implemented method of claim 20, wherein the compressor LM is configured to concurrently perform a re-ranking operation that reorders the retrieved set of documents.

25. The computer-implemented method of claim 20, wherein the retrieving of the set of documents concurrently performs a re-ranking operation based on the compressed representation of the retrieved set of documents.

26. The computer-implemented method of claim 24, wherein the re-ranking is performed:
by a language model; or
based on a predefined criterion.

27. The computer-implemented method of claim 24, wherein the re-ranking is performed:
by a language model; or
the re-ranking is performed based on a predefined criterion.

28. The computer-implemented method of claim 20, wherein the compressor LM includes a compressor adapter which adapts the compressor LM to perform compression.

29. The computer-implemented method of claim 20, wherein the generator LM includes a generator adapter which adapts the generator LM to perform the generation.

30. A system comprising:
one or more data processors; and
a non-transitory computer readable storage medium containing instruction which, when executed on the one or more data processors, cause the one or more data processors to perform a set of operations including:
accessing a set of training queries;
for each training query of the set of training queries:
retrieving a set of training documents from a training document collection;
inputting a training query of the set of training queries and the retrieved set of training documents into a teacher language model (LM) to obtain a teacher answer;
generating, for each training document of the retrieved set of training documents, a compressed representation by using a compressor LM;
processing the query and each of the compressed representation of each training document of the retrieved set of training documents with a generator LM;
determining a value of a loss function based on the teacher answer and the processing using the generator LM;
updating, based on the value of the loss function, the compressor LM and the generator LM by using a backpropagation technique; and
outputting, based on the updating of the compressor LM and the generator LM, a trained compressor LM and a trained generator LM;
wherein the trained compressor LM is configured to perform a re-ranking operation.
